(19) United States
(12) Patent Application Publication
(10) Pub. No.: US 2026/0196762 A1
(43) Pub. Date: Jul. 9, 2026

(54) CONNECTOR

(71) Applicant: SUMITOMO WIRING SYSTEMS, LTD., Mie (JP)

(72) Inventor: Nagito NARITA, Mie (JP)

(21) Appl. No.: 19/440,988

(22) Filed: Jan. 6, 2026

(30) Foreign Application Priority Data
Jan. 9, 2025 (JP) 2025-003456

(51) Int. Cl. H01R 13/506; H01R 13/56

(52) U.S. Cl. CPC H01R 13/506; H01R 13/56

(57) ABSTRACT

A connector includes a housing having a cover fixing portion, and a non-split-type electric wire cover assembled to the cover fixing portion in a lower direction. The non-split-type electric wire cover is configured to cover an electric wire group that is pulled out from an electric wire pull-out surface of the cover fixing portion and is bent. The housing includes latching portions provided on an outer peripheral surface of the cover fixing portion. The electric wire cover includes a peripheral wall that is externally fitted onto the outer peripheral surface of the cover fixing portion and that has a cutout portion in a part in the peripheral direction along the outer peripheral surface, and portions to be latched that are provided on the peripheral wall and that are latched by the latching portions.

### CROSS-REFERENCE TO RELATED APPLICATIONS

This application is based on and claims priority from Japanese Patent Application No. 2025-003456, filed on January 9, 2025, with the Japan Patent Office, the disclosure of which is incorporated herein in its entirety by reference.

### TECHNICAL FIELD

The present disclosure relates to a connector.

### BACKGROUND

Hitherto, a connector including an electric wire cover assembled to a housing has been known. The electric wire cover covers an electric wire group that is bent in a predetermined direction after being pulled out from the housing. The electric wire cover protects the electric wire group and restricts the lead-out direction of the electric wire group.

For example, an electric wire cover in a connector described in Japanese Patent Laid-Open Publication No. 2010-009875 is constituted by a first half-split cover and a second half-split cover. By combining the first half-split cover and the second half-split cover, a cylindrical electric wire cover that surrounds the outer periphery of an electric wire group pulled out from a housing is formed. According to the electric wire cover having a split configuration as above, the electric wire cover can be attached afterwards to the housing that is in a state in which the electric wire group is pulled out. However, in the assembly of the electric wire cover as above, there is a need to latch the first half-split cover and the second half-split cover with each other while also latching the first half-split cover and the second half-split cover with the housing. Therefore, the work of assembling the electric wire cover becomes complicated.

Meanwhile, an electric wire cover in a connector described in Japanese Patent Laid-Open Publication No. 2016-219308, for example, is a non-split-type electric wire cover that can be attached afterwards. In the electric wire cover disclosed in Japanese Patent Laid-Open Publication No. 2016-219308, a cutout is formed in a part of a peripheral wall that is externally fitted onto an outer peripheral surface of a cover fixing portion of a housing. Therefore, when the electric wire cover is assembled, an electric wire group can be accommodated in the electric wire cover through the cutout.

### SUMMARY

In a non-split-type electric wire cover as that in Japanese Patent Laid-Open Publication No. 2016-219308, a cutout for letting an electric wire group to pass therethrough at the time of assembly to a housing is needed. Therefore, when the electric wire cover opens such that the cutout is expanded, there is a risk that the electric wire cover may come off and fall from the housing.

An object of the present disclosure is to provide a connector capable of suppressing falling of an electric wire cover due to opening of the electric wire cover.

This object is solved according to the invention by the features of the independent claims. Particular embodiments of the invention are subject of the dependent claims.

A connector of the present disclosure includes a housing having a cover fixing portion, and a (particularly) non-split-type electric wire cover to be assembled to the cover fixing portion substantially in a first direction. The (particularly non-split-type) electric wire cover is configured to at least partly cover an electric wire group that is pulled out from the cover fixing portion and bent. The housing includes at least one latching portion provided on an outer peripheral surface of the cover fixing portion. The electric wire cover includes a peripheral wall that is externally fitted onto the outer peripheral surface of the cover fixing portion and that has at least one cutout portion in a part in a peripheral direction along the outer peripheral surface, and at least one latchable portion (i.e. portion to be latched) that is provided on the peripheral wall and that is or can be latched by the latching portion. The electric wire group at least partly is accommodatable in the electric wire cover by being passed through the cutout portion when the electric wire cover is assembled to the cover fixing portion in the first direction. At least one reinforcement rib is provided on the electric wire cover.

Accordingly to this configuration, it becomes possible to improve the rigidity of the electric wire cover by the reinforcement rib. Therefore, it becomes possible to suppress a case in which the electric wire cover opens such that the cutout portion is expanded and the electric wire cover falls from the housing.

According to a specific embodiment, the peripheral wall of the electric wire cover may include a rear wall portion configured to at least partly cover a rear side of the electric wire group that substantially extends to the front side after being bent in the electric wire cover, and/or a pair of side wall portions that substantially face each other in the width direction orthogonal to the front-rear direction.

Further specifically, the electric wire cover may include an upper wall portion that is connected to each upper end of the pair of side wall portions and to an upper end of the rear wall portion.

According to this configuration, it becomes possible to suitably protect the electric wire group by each of the side wall portions, the rear wall portion, and/or the upper wall portion in the electric wire cover.

Further specifically, the reinforcement rib may include at least one first rib that substantially continuously extends from the upper wall portion to each of the side wall portions.

According to this configuration, by the first rib(s) that substantially continuously extend(s) from the upper wall portion to each of the side wall portions, it becomes possible to suppress the increase of the interval between the pair of side wall portions.

As a result, it becomes possible to suppress the falling of the electric wire cover.

Further specifically, the reinforcement rib may include at least one second rib that substantially continuously extends from each of the side wall portions to the rear wall portion.

According to this configuration, by the second rib(s) that substantially continuously extend(s) from each of the side wall portions to the rear wall portion, it becomes possible to suppress the increase of the interval between the pair of side wall portions.

As a result, it becomes possible to suppress the falling of the electric wire cover.

Further specifically, the reinforcement rib may include at least one third rib that is provided on an inner side surface of each of the side wall portions and/or that substantially extends along the first direction.

According to this configuration, it becomes possible to improve the rigidity of the electric wire cover by the third rib provided on the inner side surface of the side wall portion.

Further specifically, the third rib may have, on or near an end portion of the third rib in the first direction, an abutment portion abuttable against the housing in the first direction.

According to this configuration, the abutment portion of the third rib substantially can abut against the housing in the first direction, and hence it becomes possible to position the electric wire cover in the first direction.

As a result, even when the electric wire cover receives an external force and is pushed substantially in the first direction, the abutment portion of the third rib abuts against the housing, and hence the release of the latching between the latching portion of the housing and the latchable portion of the electric wire cover is suppressed.

Further specifically, the housing may include at least one fitting recessed portion into which the abutment portion is fit.

Further specifically, and the abutment portion may be configured to be abuttable against the fitting recessed portion in the first direction and the front-rear direction.

According to this configuration, the abutment portion of the third rib is fitted into the fitting recessed portion in the housing, and hence it becomes possible to position the electric wire cover not only in the first direction but also in the front-rear direction.

As a result, it becomes possible to suppress the falling of the electric wire cover even more.

Further specifically, two latchable portions are provided on the peripheral wall adjacent to the cutout portion.

As a result, the electric wire cover can be more securely and/or stably mounted to the housing.

According to the connector of the present disclosure, it becomes possible to suppress falling of the electric wire cover due to opening of the electric wire cover.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connect or in one embodiment.

FIG. 2 is an exploded perspective view of the connector in the same embodiment.

FIG. 3 is a perspective view showing a configuration near an electric wire cover in the connector of the same embodiment.

FIG. 4 is a cross-sectional perspective view showing a part of the connector in the same embodiment.

FIG. 5 is a cross-sectional view showing a part of the connector in the same embodiment.

FIG. 6 is a bottom view of the electric wire cover in the same embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

In each drawing, an X-axis, a Y-axis, and a Z-axis are illustrated to be orthogonal to each other. The front-rear direction of the connector is along the X-axis, and a front direction X1 along the X-axis and a rear direction X2 in the opposite direction thereof are illustrated in each drawing.

Specifically, the width direction of the connector is along the Y-axis, and one width direction Y1 that is one of the width direction along the Y-axis and another width direction Y2 in the opposite direction thereof are illustrated in each drawing.

The height direction of the connector particularly is along the Z-axis, and an upper direction Z1 that is one of the height direction along the Z-axis and a lower direction Z2 in the opposite direction thereof are illustrated in each drawing. The connector is not necessarily used in a posture in which the upper direction Z1 faces the upward direction.

The term "orthogonal" in the present specification is not limited to a case of being strictly orthogonal and also includes being substantially orthogonal within a range in which functions and effects in the present embodiment are exhibited.

The term "cylindrical shape" used in the description of the present specification is not limited to a form in which a peripheral wall is continuously formed along the entire periphery in the peripheral direction and particularly includes a form in which a cylinder is formed by combining a plurality of parts and a form in which a cutout and the like are included in a part in the peripheral direction such as a C-shaped form.

The outer peripheral shape of the "cylindrical shape" particularly includes a circular shape, an elliptical shape, and a polygon having sharp or round corners but is not limited thereto. The term "cylindrical shape" means a shape having a through-hole in plan view and includes a shape in which the outer peripheral shape and the inner peripheral shape of the through-hole are the same shapes, and a shape in which the outer peripheral shape and the inner peripheral shape of the through-hole are different shapes. The term "cylindrical shape" includes a shape having a predetermined length extending along the axial direction in which the central axis that pass through the through-hole extends, and the magnitude of the length is not limited.

The expression of "facing" in the present specification particularly means that surfaces or members are located in front of each other and not only includes a case in which the surfaces or the members are located completely in front of each other but also includes a case in which the surfaces or the members are partially located in front of each other.

The expression of "facing" in the present specification particularly includes both of a case in which a member other than two parts is interposed between those two parts and a case in which nothing is interposed between two parts.

Terms such as "first", "second", "third", and "fourth" in the present specification are simply used in order to distinguish objects and do not rank the objects.

The present invention is not limited to the exemplifications above, and is defined by the scope of claims. All modifications made within the scope and spirit equivalent to those of the claims are intended to be included in the invention.

### Configuration of Connector 10

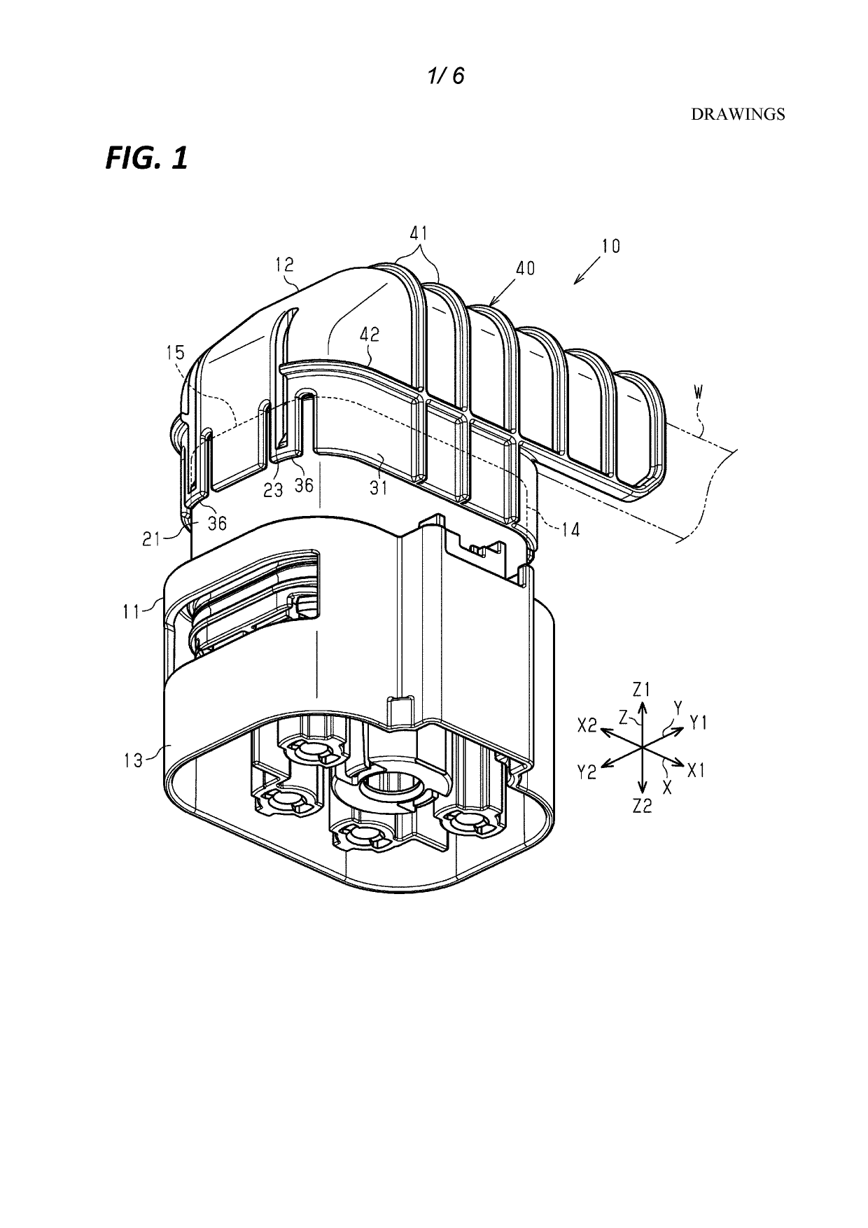

A connector 10 of the present embodiment shown in FIG. 1 is mounted on a vehicle, for example. The connector 10 includes a housing 11 and an electric wire cover 12 assembled to the housing 11 particularly substantially along or in the lower direction Z2.

The electric wire cover 12 particularly is a non-split-type electric wire cover that at least partly covers one or more wires, particularly an electric wire group W pulled out from the housing 11.

The electric wire group W specifically includes one or a plurality of high-voltage electric wires each having a large diameter and capable of handling high voltage and large current, for example.

Each electric wire included in the electric wire group W is connected to a terminal (not shown) at least partly accommodated inside the housing 11. The housing 11 is formed by synthetic resin.

The electric wire cover 12 specifically is formed by a high-rigidity material such as synthetic resin containing glass fiber, for example.

### Configuration of Housing 11

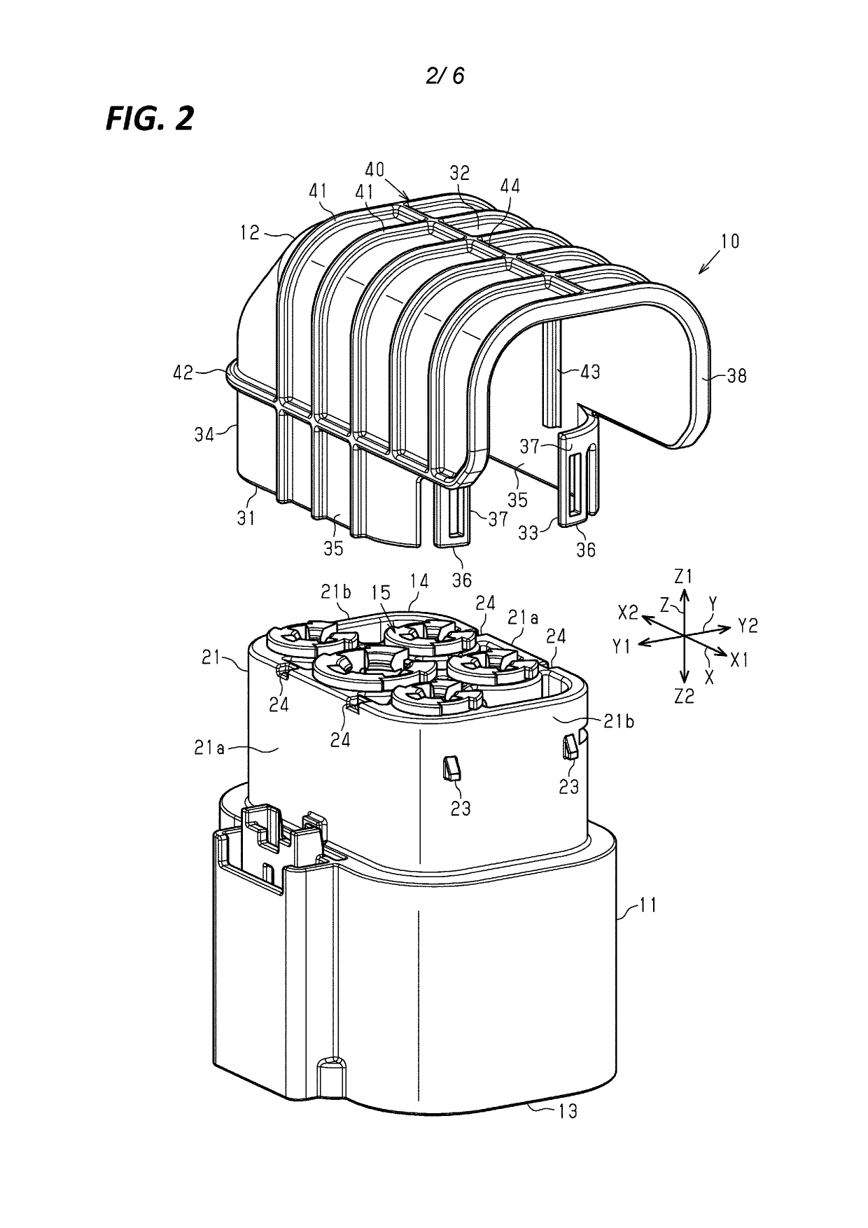

As shown in FIG. 1 and FIG. 2, the housing 11 includes, particularly at an end portion of the housing 11 in the lower direction Z2 thereof, a fitting portion 13 to be at least partly fitted with a counterpart or mating connector (not shown).

The fitting portion 13 is assembled to the counterpart or mating connector particularly substantially along or in the lower direction Z2.

The housing 11 includes, on an end portion of the housing 11 (particularly substantially in the upper direction Z1 thereof), a cover fixing portion 14 to which an electric wire cover 12 is to be attached of fixed.

The cover fixing portion 14 particularly has at least one electric wire pull-out surface 15 specifically on an upper end surface of the cover fixing portion 14.

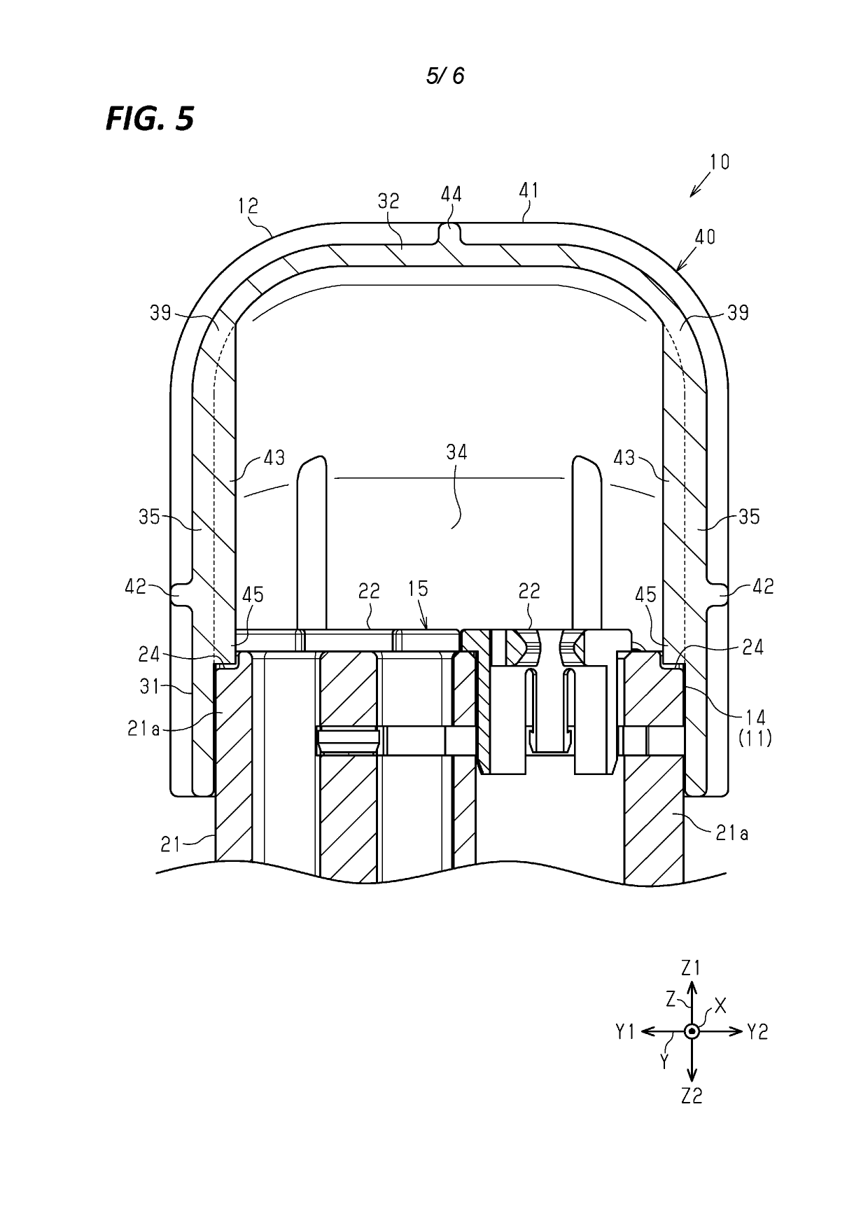

In FIG. 2 and FIG. 5, the illustration of the electric wire group W is omitted for explanatory convenience. The electric wire group W particularly is temporarily pulled out from the cover fixing portion 14 (particularly substantially along or in the upper direction Z1) and then is bent in a direction intersecting with the Z-axis inside the electric wire cover 12.

In the present embodiment, the electric wire group W particularly is bent substantially at a right angle inside the electric wire cover 12 and is pulled out toward the front direction X1 to the outside of the electric wire cover 12.

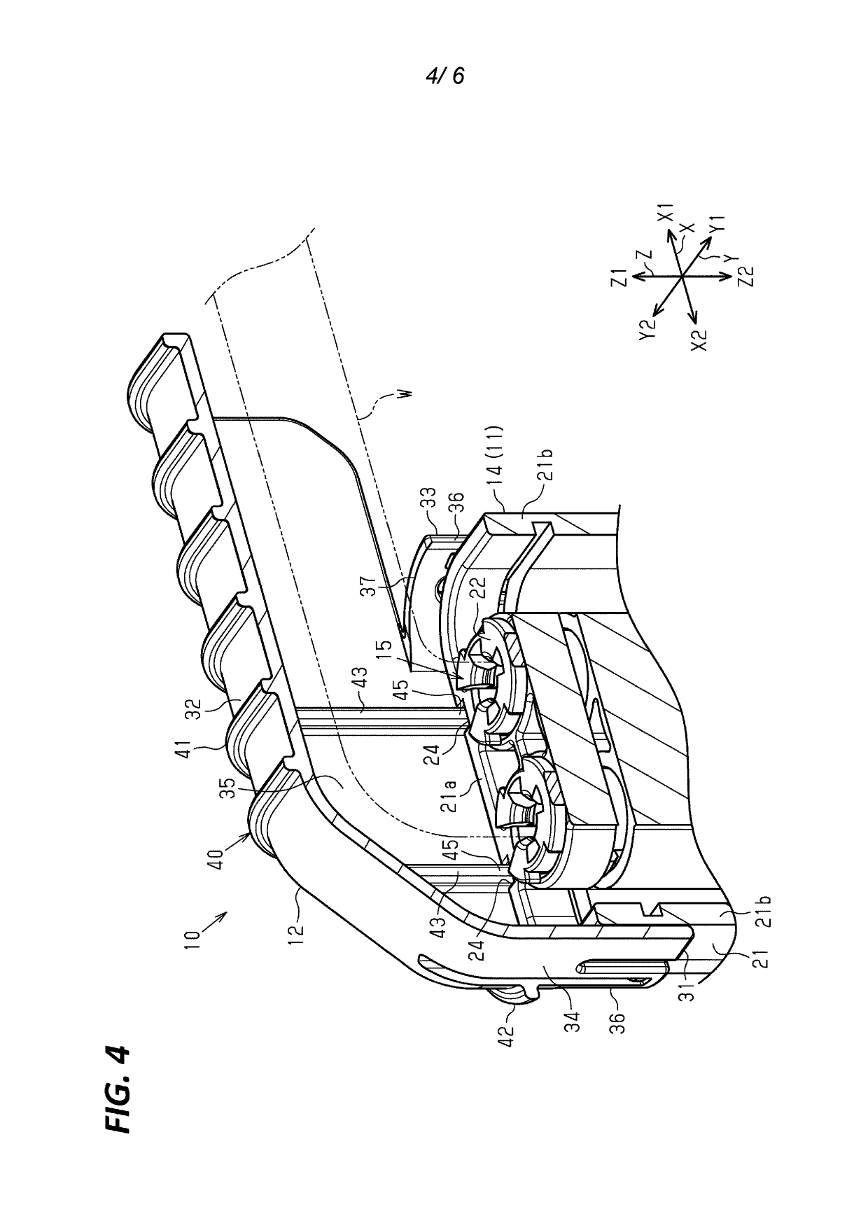

As shown in FIG. 2 and FIG. 4, the cover fixing portion 14 of the housing 11 includes an outer peripheral wall 21 and/or one or more, particularly a plurality of rear holders 22 that configure the electric wire pull-out surface 15.

Each of the rear holders 22 particularly is provided on the inner side of the outer peripheral wall 21.

Each of the rear holders 22 particularly holds a corresponding one of the electric wires configuring the electric wire group W, and/or the electric wires are pulled out (particularly substantially toward the upper direction Z1) from the rear holders 22.

The electric wire group W particularly is formed by bundling the electric wires pulled out from the rear holders 22 inside the electric wire cover 12.

Specifically, the outer peripheral wall 21 of the cover fixing portion 14 includes a pair of first wall portions 21a that substantially face each other in the width direction (Y-axis direction) and a pair of second wall portions 21b that substantially face each other in the front-rear direction (X-axis direction).

When the cover fixing portion 14 is seen in the lower direction Z2, the outer peripheral wall 21 particularly forms a substantially rectangular shape in which each corner is curved, the pair of first wall portions 21a form long sides extending in the front-rear direction, and the pair of second wall portions 21b form short sides extending in the width direction, for example.

The housing 11 includes one or more latching portions 23 provided on (particularly an outer peripheral surface of) the outer peripheral wall 21 of the cover fixing portion 14.

Specifically, the latching portions 23 are provided on each of the second wall portions 21b and are not provided on the first wall portions 21a in the outer peripheral wall 21, for example.

The latching portions 23 protrude from an outer surface of each of the second wall portions 21b, for example.

Specifically, two latching portions 23 are provided on each of the pair of second wall portions 21b, for example.

The housing 11 includes one or more fitting recessed portions 24 provided in the cover fixing portion 14. Specifically, the fitting recessed portions 24 are provided in an upper or distal end portion of each of the first wall portions 21a in the cover fixing portion 14, for example.

Two fitting recessed portions 24 particularly are provided in each of the pair of first wall portions 21a, for example.

### Configuration of Electric Wire Cover 12

The electric wire cover 12 particularly includes a peripheral wall 31 to be fitted to the cover fixing portion 14, particularly externally fitted to the outer peripheral wall 21 of the cover fixing portion 14.

The electric wire cover 12 particularly an upper wall portion 32 that at least partly covers the upper side of the electric wire group W.

The peripheral wall 31 particularly is or is to be assembled to the outer peripheral wall 21 of the cover fixing portion 14 substantially in the lower direction Z2.

The peripheral wall 31 particularly has a cutout portion 33 in a part in the peripheral direction along the outer peripheral wall 21.

When the electric wire cover 12 is assembled to the cover fixing portion 14 in the lower direction Z2, the electric wire group W in which the plurality of electric wires particularly are bundled at least partly is accommodatable in the electric wire cover 12 by being passed through the cutout portion 33.

### Configuration of Peripheral Walls 31

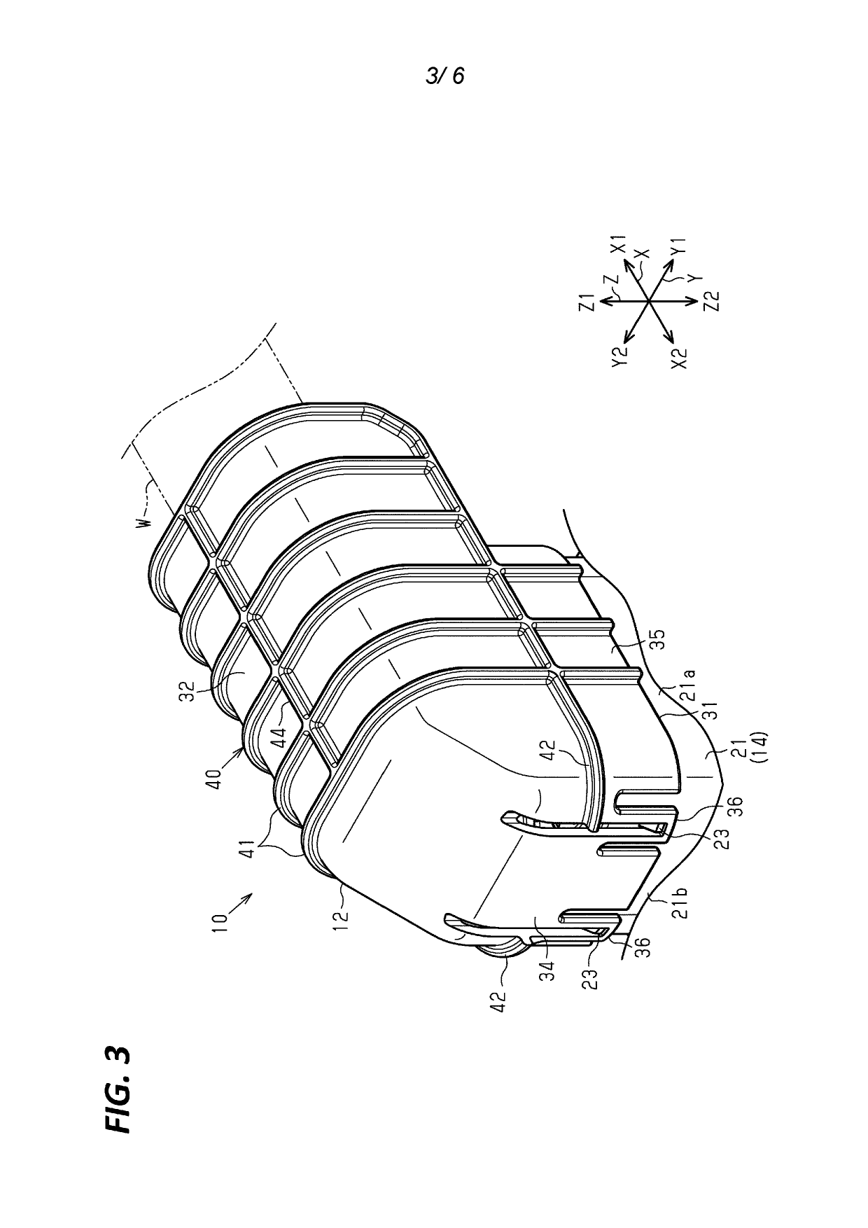

As shown in FIG. 3, the peripheral wall 31 of the electric wire cover 12 particularly includes a rear wall portion 34 that at least partly covers the rear direction X2 side of the electric wire group W.

The rear wall portion 34 particularly abuts on or against an outer surface of the second wall portion 21b on the rear side in the outer peripheral wall 21 of the cover fixing portion 14.

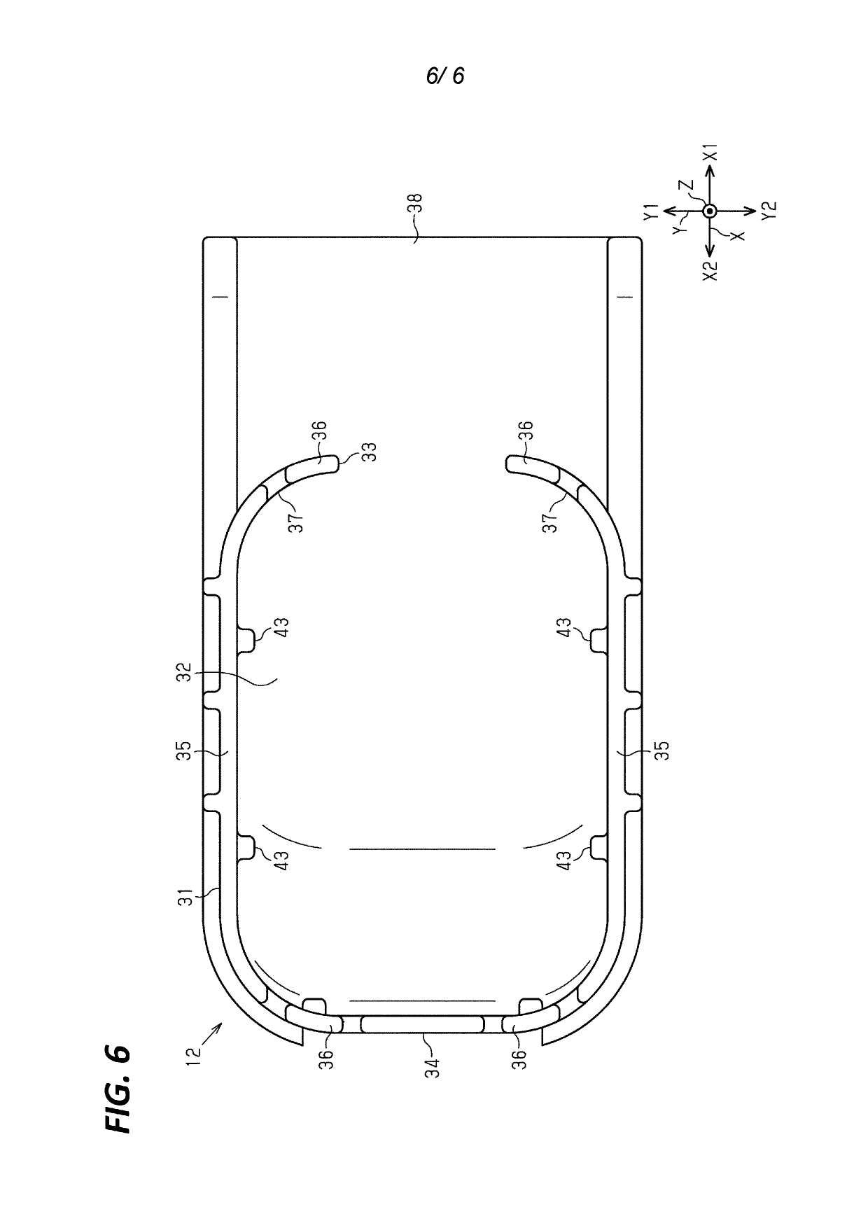

As shown in FIG. 5 and FIG. 6, the peripheral wall 31 of the electric wire cover 12 particularly includes one or more, particularly a pair of side wall portions 35 that substantially face each other in the width direction (Y-axis direction).

FIG. 5 is a cross-sectional view of the connector 10 taken along a YZ-plane perpendicular to the X-axis direction (front-rear direction). Each of the side wall portions 35 particularly substantially is connected to the rear wall portion 34.

Each of the side wall portions 35 particularly abuts against or on an outer surface of a corresponding one of the first wall portions 21a in the outer peripheral wall 21 of the cover fixing portion 14.

The upper wall portion 32 of the electric wire cover 12 particularly is connected to each of upper ends of the pair of side wall portions 35 and an upper end of the rear wall portion 34.

Each of the side wall portions 35 at least partly cover the electric wire group W in the width direction.

As shown in FIG. 2 and FIG. 3, the peripheral wall 31 of the electric wire cover 12 includes one or more latchable portions 36 to be latched by the latching portions 23 of the housing 11. In the peripheral wall 31, the latchable portions 36 are provided by the same number as the latching portions 23 (in the present embodiment, four).

In detail, as shown in FIG. 3, two latchable portions 36 are provided on the rear wall portion 34 in the peripheral wall 31.

As shown in FIG. 2, the peripheral wall 31 particularly includes one or more, particularly a pair of extending wall portions 37.

Specifically, the extending wall portions 37 substantially extend from end portions of the side wall portions 35 in the front direction X1 thereof to the front side of the second wall portion 21b of the cover fixing portion 14.

The one or more, particularly the pair of extending wall portions 37 (particularly each) include the latchable portion 36.

Each of the latchable portions 36 are latched with a corresponding one of the latching portions 23 substantially along or in the upper direction Z1.

As shown in FIG. 2 and FIG. 3, the electric wire cover 12 particularly has a lead-out portion 38.

Specifically, the lead-out portion 38 substantially extends in the front direction X1 from the upper wall portion 32 and each of the side wall portions 35.

The lead-out portion 38 particularly substantially opens in the front direction X1 and the lower direction Z2.

The electric wire group W is or can be at least partly led out from the lead-out portion 38 in the front direction X1.

### Configuration of Reinforcement Ribs 40

One or more, particularly a plurality of reinforcement ribs 40 are provided on the electric wire cover 12.

Specifically, the reinforcement ribs 40 include one or more first ribs 41, one or more second ribs 42, one or more third ribs 43, and at least one fourth rib 44.

### Configuration of First Ribs 41

The one or more first ribs 41 particularly are formed on an outer surface of the electric wire cover 12, for example.

The first ribs 41 particularly substantially continuously extend from the upper wall portion 32 to each of the side wall portions 35.

Specifically, the electric wire cover 12 has a plurality (for example, three) first ribs 41.

The first ribs 41 particularly substantially linearly extend along the width direction (Y-axis direction), for example, in the upper wall portion 32.

The first ribs 41 particularly substantially linearly extend along the height direction (Z-axis direction), for example, in each of the side wall portions 35.

The first ribs 41 particularly extend to a lower end portion (an end portion in the lower direction Z2) of each of the side wall portions 35, for example.

### Configuration of Second Ribs 42

The one or more second ribs 42 are formed on the outer surface of the electric wire cover 12, for example.

The second ribs 42 particularly substantially continuously extend from the side wall portions 35 to the rear wall portion 34.

The electric wire cover 12 particularly is provided so as to correspond to each of the side wall portions 35.

The second ribs 42 particularly substantially linearly extend along the front-rear direction (X-axis direction), for example, in the side wall portions 35.

In the second ribs 42, sections that extend to the rear wall portion 34 particularly are located above the latchable portions 36.

### Configuration of Third Ribs 43

As shown in FIG. 4, FIG. 5, and FIG. 6, the one or more third ribs 43 are provided on inner side surfaces of the side wall portions 35.

The third ribs 43 particularly are provided on each of the inner side surfaces of the side wall portions 35 by a plurality of numbers (for example, two).

The third ribs 43 particularly substantially extend along the height direction (Z-axis direction).

Specifically, as shown in FIG. 5, upper end portions of the third ribs 43 substantially extend to corner portions 39 at which the side wall portions 35 and the upper wall portion 32 are connected in the electric wire cover 12, for example.

Each of the third ribs 43 particularly has, at or near an end portion of each of the third ribs 43 in the lower direction Z2 thereof, an abutment portion 45 that is abuttable against the housing 11 in the lower direction Z2.

Each of the abutment portions 45 at least partly is fit or fittable into a corresponding one of the one or more fitting recessed portions 24 formed in an upper end portion of the outer peripheral wall 21 in the cover fixing portion 14.

The abutment portions 45 particularly are abuttable substantially toward the lower direction Z2 against bottom surfaces of the fitting recessed portions 24.

As a result of the abutment portions 45 of the third ribs 43 abutting against the housing 11 in the lower direction Z2, the electric wire cover 12 particularly substantially is positioned in the lower direction Z2.

The abutment portions 45 particularly are abuttable against side surfaces of the fitting recessed portions 24 in the front direction X1 and the rear direction X2.

As a result, the electric wire cover 12 particularly is positioned in the front-rear direction.

### Configuration of Fourth Rib(s) 44

As shown in FIG. 3, the at least one fourth rib 44 is provided on an outer surface of the upper wall portion 32, for example.

The fourth rib 44 particularly substantially linearly extends along the front-rear direction (X-axis direction), for example.

The fourth rib 44 particularly intersects with the first ribs 41 on the upper wall portion 32.

### Functions of Present Embodiment

Functions of the present embodiment are described below.

The rigidity of the electric wire cover 12 is improved by forming the one or more reinforcement ribs 40.

Therefore, even when the connector 10 receives external force such as vibration, it is possible to substantially suppress a case in which the electric wire cover 12 opens such that the cutout portion 33 is expanded and the electric wire cover 12 falls from the housing 11.

In particular, the one or more first ribs 41 included in the reinforcement ribs 40 substantially continuously extend from the upper wall portion 32 to each of the side wall portions 35.

Therefore, as a result of forming the first rib(s) 41, each of the side wall portions 35 does not easily open to the outer side in the width direction.

The one or more second ribs 42 included in the reinforcement ribs 40 particularly substantially continuously extend from the side wall portions 35 to the rear wall portion 34.

Therefore, a case in which each of the side wall portions 35 opens can also be suppressed by the second rib(s) 42.

The one or more third ribs 43 formed on the inner side surfaces of the side wall portions 35 extend to the upper wall portion 32 (in detail, the corner portions 39), and hence a case in which each of the side wall portions 35 opens can also be suppressed by the third ribs 43.

In the connector 10 of the present embodiment, the one or more latching portions 23 and the one or more fitting recessed portions 24 provided in the housing 11 and the one or more latchable portions 36 and the abutment portions 45 (third ribs 43) provided in the electric wire cover 12 particularly are provided in substantially symmetrical locations.

Therefore, it is possible to assemble the electric wire cover 12 to the cover fixing portion 14 even when the electric wire cover 12 is placed in a direction reversed by 180 degrees such that the lead-out portion 38 faces the rear direction X2.

As a result, it becomes possible to change the lead-out direction of the electric wire group W without changing the electric wire cover 12.

### Effects of Present Embodiment

Effects of the present embodiment are described below.

(1) The one or more reinforcement ribs 40 particularly are provided on the non-split-type electric wire cover 12, and hence it becomes possible to improve the rigidity of the electric wire cover 12 even with a non-split-type.

Therefore, it particularly becomes possible to suppress a case in which the electric wire cover 12 opens such that the cutout portion 33 is expanded and the electric wire cover 12 falls from the housing 11.

(2) The peripheral wall 31 of the electric wire cover 12 particularly includes the rear wall portion 34 configured to at least partly cover the rear side of the electric wire group W that substantially extends to the front side after being bent in the electric wire cover 12, and the one or more side wall portions 35, particularly the pair of side wall portions 35 that substantially face each other in the width direction orthogonal to the front-rear direction.

The electric wire cover 12 particularly includes the upper wall portion 32.

Specifically, the upper wall portion 32 is connected to each of the upper ends of the pair of side wall portions 35 and the upper end of the rear wall portion 34.

According to this configuration, it becomes possible to suitably protect the electric wire group W by (particularly each of) the side wall portions 35, the rear wall portion 34, and/or the upper wall portion 32 in the electric wire cover 12.

(3) The one or more reinforcement ribs 40 particularly include the one or more first ribs 41 that substantially continuously extend from the upper wall portion 32 to each of the side wall portions 35.

According to this configuration, by the first ribs 41 that substantially continuously extend from the upper wall portion 32 to each of the side wall portions 35, it becomes possible to suppress the increase of the interval between the pair of side wall portions 35.

As a result, it becomes possible to suppress the falling of the electric wire cover 12.

(4) The one or more reinforcement ribs 40 particularly include the one or more second ribs 42 that substantially continuously extend from the side wall portions 35 to the rear wall portion 34.

According to this configuration, by the second ribs 42 that substantially continuously extend from the side wall portions 35 to the rear wall portion 34, it becomes possible to suppress the increase of the interval between the lower end portions of the pair of side wall portions 35.

As a result, it becomes possible to suppress the falling of the electric wire cover 12.

(5) The one or more reinforcement ribs 40 particularly include the one or more third ribs 43 that are provided on the inner side surface(s) of the side wall portion(s) 35 and/or that substantially extend along the lower direction Z2.

According to this configuration, it becomes possible to improve the rigidity of the electric wire cover 12 by the third ribs 43 provided on the inner side surfaces of the side wall portions 35.

(6) Specifically, the one or more third ribs 43 (particularly each) have, at the end portion of each of the third ribs 43 in the lower direction Z2 thereof, the abutment portion 45 that is abuttable against the housing 11 in the lower direction Z2.

According to this configuration, the abutment portions 45 of the third ribs 43 particularly abut against or on the housing 11 in the lower direction Z2, and hence it becomes possible to position the electric wire cover 12 in the lower direction Z2.

As a result, even when the electric wire cover 12 receives an external force and is pushed in the lower direction Z2, the abutment portions 45 of the third ribs 43 abut against the housing 11, and hence the release of the latching between the latching portions 23 of the housing 11 and the latchable portions 36 of the electric wire cover 12 is suppressed.

(7) The housing 11 particularly includes the one or more fitting recessed portions 24 into which the one or more abutment portions 45 fit.

The one or more abutment portions 45 particularly are configured to be abuttable against the fitting recessed portions 24 substantially in the lower direction Z2 and the front-rear direction.

According to this configuration, the abutment portion(s) 45 of the third rib(s) 43 particularly is/are fitted into the fitting recessed portion(s) 24 in the housing 11, and hence it becomes possible to position the electric wire cover 12 not only substantially in the lower direction Z2 but also substantially in the front-rear direction. As a result, it becomes possible to suppress the falling of the electric wire cover 12 even more.

Accordingly, there is provided a connector capable of suppressing the falling of an electric wire cover due to opening of the electric wire cover is provided. A connector 10 includes a housing 11 having at least one cover fixing portion 14, and a non-split-type electric wire cover 12 assembled to the cover fixing portion 14 particularly in or along a lower direction Z2.

The non-split-type electric wire cover 12 is configured to at least partly cover an electric wire group that is or can be pulled out from an electric wire pull-out surface 15 of the cover fixing portion 14 and/or is bent.

The housing 11 includes one or more latching portions 23 provided on or at an outer peripheral surface of the cover fixing portion 14.

The electric wire cover 12 includes a peripheral wall 31 that at least partly is externally fitted onto the outer peripheral surface of the cover fixing portion 14 and/or that has a cutout portion 33 in a part in the peripheral direction along the outer peripheral surface.

The electric wire cover 12 further includes one or more portions to be latched 36 (or latchable portions 36) that are provided on the peripheral wall 31 and/or that are to be latched by the one or more latching portions 23.

The electric wire group at least partly is accommodatable in the electric wire cover 12 by being passed through the cutout portion 33 when the electric wire cover 12 is assembled to the cover fixing portion 14 in the lower direction Z2.

Specifically, one or more reinforcement ribs 40 are provided on the electric wire cover 12.

### Other Embodiments

The embodiment described above can be carried out by being changed as below. The embodiment described above and modified examples below can be carried out by being combined with each other without being technically inconsistent.

● Configurations such as the shapes of the reinforcement ribs 40 in the electric wire cover 12 are not limited to the embodiment described above and can be changed, as appropriate, in accordance with the configuration of the connector 10.

● In the cover fixing portion 14 of the housing 11 in the embodiment described above, the fitting recessed portions 24 may be omitted and the abutment portions 45 of the third ribs 43 on the electric wire cover 12 may simply abut against the upper end portion of the outer peripheral wall 21.

● In the electric wire cover 12, a configuration in which the one or more third ribs 43 do not have the abutment portion(s) 45 may be employed. In other words, a configuration in which the third ribs 43 do not abut against the outer peripheral wall 21 of the cover fixing portion 14 in the lower direction Z2 may be employed.

● A configuration in which the one or more first ribs 41 do not extend to the lower end portions of the side wall portions 35 may be employed.

● A configuration in which the one or more third ribs 43 do not extend to the upper wall portion 32 (corner portions 39) may be employed.

● In the reinforcement ribs 40, the number of the first ribs 41, the second ribs 42, the third ribs 43, and/or the fourth ribs 44 is not limited to that in the embodiment described above and can be changed, as appropriate, in accordance with the configuration of the connector 10.

● A configuration obtained by omitting at least one of the first ribs 41, the second ribs 42, the third ribs 43, and the fourth rib 44 out of the reinforcement ribs 40 in the embodiment described above may be employed.

● In the embodiment described above, the one or more latchable portions 36 of the electric wire cover 12 formed as recessed portions are latched by the one or more latching portions 23 of the housing 11 particularly formed as protruding portions, but the relationship of recessed portions and protruding portions may be opposite between the latching portions 23 and the latchable portions 36.

● In the embodiment described above, the electric wire group W is bent substantially at a right angle in the electric wire cover 12, but the present invention is not limited thereto, and the electric wire group W may be bent at an angle less than 90 degrees or an angle more than 90 degrees.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing having a cover fixing portion; and
a electric wire cover to be assembled to the cover fixing portion substantially in a first direction, the electric wire cover being configured to at least partly cover an electric wire group that is pulled out from an electric wire pull-out surface of the cover fixing portion and is bent, wherein:
the housing includes at least one latching portion provided on an outer peripheral surface of the cover fixing portion;
the electric wire cover includes:
a peripheral wall that is externally fitted onto the outer peripheral surface of the cover fixing portion and that has at least one cutout portion in a part in a peripheral direction along the outer peripheral surface; and
at least one latchable portion that is provided on the peripheral wall and that is latched by the latching portion;
the electric wire group at least partly is accommodatable in the electric wire cover by being passed through the cutout portion when the electric wire cover is assembled to the cover fixing portion in the first direction; and
at least one reinforcement rib is provided on the electric wire cover.

2. The connector according to claim 1, wherein:
the peripheral wall of the electric wire cover includes:
a rear wall portion configured to at least partly cover a rear side of the electric wire group that substantially extends to a front side after being bent in the electric wire cover; and/or
a pair of side wall portions that substantially face each other in a width direction orthogonal to a front-rear direction.

3. The connector according to claim 2, wherein:
the electric wire cover includes an upper wall portion that is connected to each upper end of the pair of side wall portions and to an upper end of the rear wall portion.

4. The connector according to claim 3, wherein:
the reinforcement rib includes at least one first rib that substantially continuously extends from the upper wall portion to each of the side wall portions.

5. The connector according to claim 3, wherein:
the reinforcement rib includes at least one second rib that substantially continuously extends from each of the side wall portions to the rear wall portion.

6. The connector according to claim 2, wherein:
the reinforcement rib includes at least one third rib that is provided on an inner side surface of each of the side wall portions and/or that substantially extends along the first direction.

7. The connector according to claim 6, wherein:
the third rib has, on or near an end portion of the third rib in the first direction, an abutment portion abuttable against the housing substantially in the first direction.

8. The connector according to claim 7, wherein:
the housing includes at least one fitting recessed portion into which the abutment portion at least partly is fit.

9. The connector according to claim 8, wherein:
the abutment portion is configured to be abuttable against the fitting recessed portion in the first direction and the front-rear direction.

10. The connector according to claim 1, wherein:
two latchable portions are provided on the peripheral wall adjacent to the cutout portion.
